(19) United States
(12) Patent Application Publication
(10) Pub. No.: US 2012/0056902 A1
(43) Pub. Date: Mar. 8, 2012

(54) MULTI-DISPLAY APPARATUS

(75) Inventor: Hiroki Yoshino, Osaka (JP)

(73) Assignee: SHARP KABUSHIKI KAISHA, Osaka (JP)

(21) Appl. No.: 13/227,857

(22) Filed: Sep. 8, 2011

(30) Foreign Application Priority Data
Sep. 8, 2010 (JP) 2010-201249

(51) Int. Cl. G09G 5/00

(52) U.S. Cl. 345/660

(57) ABSTRACT

A multi-display apparatus including a display unit 1 constituted by plural displays 11 detects that a viewer who is watching an image showed on the display unit 1 is present in a near region, and shows an image with the size thereof adjusted based on the detected result on the display unit 1. For example, the multi-display apparatus shows a small image on the display unit 1 by reducing the number of displays 11 used for image display when a viewer is present in the near region, allowing the viewer in the near region to easily see the image. Moreover, the multi-display apparatus shows a large image on the display unit 1 when no viewer is present in the near region, allowing a viewer outside the near region to easily see the image.

### CROSS-REFERENCE TO RELATED APPLICATIONS

This Non-provisional application claims priority under 35 U.S.C. §119(a) on Patent Application No. 2010-201249 filed in Japan on Sep. 8, 2010, the entire contents of which are hereby incorporated by reference.

### BACKGROUND

1. Technical Field

The present invention relates to a multi-display apparatus that shows an image using a plurality of screen displays.

2. Description of Related Art

Conventionally, a multi-display apparatus in which a plurality of screen displays are combined together to configure a larger screen display has been used. In the multi-display apparatus, each screen display shows a part of an image so that a large screen constructed by a plurality of displays can show one large image. The multi-display apparatus is, for example, utilized as an information display that is installed in a store, a public space or the like to provide unidentified viewers with various pieces of information.

It is desired for such a multi-display apparatus utilized by unidentified viewers to adjust the manner of display for an image depending on the status of use by viewers. For example, if there is a screen not viewed by a viewer, image display on that screen may be turned off to attempt electrical power saving. Japanese Patent Application Laid-Open No. 2001-350549 discloses a multi-display apparatus that detects a line of sight of a viewer and turns off a display not looked by the viewer. Japanese Patent Application Laid-Open No. 2007-58687 discloses a multi-display apparatus that detects an importance of an image showed on each screen display and shows an image with high importance on a display located in the line of sight of a viewer.

### SUMMARY OF THE INVENTION

The techniques described in Japanese Patent Application Laid-Open No. 2001-350549 and Japanese Patent Application Laid-Open No. 2007-58687 require detection of the line of sight for each viewer. It is difficult to detect the lines of sight for unidentified viewers. Moreover, the lines of sight are not uniform when plural viewers are present. It is therefore difficult to apply the technique described in Japanese Patent Application Laid-Open No. 2001-350549 and Japanese Patent Application Laid-Open No. 2007-58687 to a multi-display apparatus utilized by unidentified viewers. Furthermore, with the technique described in Japanese Patent Application Laid-Open No. 2007-58687, even if an image with high importance is showed in the line of sight of a viewer, the viewer can hardly recognize the image if the viewer is far away from the multi-display apparatus. By contrast, if a viewer is too close to the multi-display apparatus, the image recognized by the viewer is too large for the viewer to see the entire image. Thus, it has been difficult with the conventional technique to adjust the manner of display for an image on the multi-display apparatus depending on the status of use by viewers.

The present invention has been made in view of the above circumstances, and its object is to provide a multi-display apparatus that can adjust a method of showing an image in accordance with a status of use by unidentified viewers.

A multi-display apparatus according to the present invention comprises: a display unit that includes plural displays and shows on each of the plural displays a part of an image larger than each display, to show the image on the display unit; a viewer detecting unit that detects that a viewer is present in a near region of the display unit; and an image adjusting unit that shows an image with a size adjusted in accordance with a result detected by the viewer detecting unit.

In the present invention, the multi-display apparatus that shows an image on a display unit including plural displays adjusts the size of the image showed by the display unit based on whether or not a viewer is present in the near region of the multi-display apparatus. Thus, the multi-display apparatus adjusts a showing method of an image in accordance with a status of use by unidentified viewers, i.e., for example, whether or not a viewer is watching the image.

In the multi-display apparatus according to the present invention, the image adjusting unit is capable of adjusting in at least two stages the size of an image showed on the display unit by increasing and reducing a number of displays used for image display on the display unit, adjusts the size of an image to be small when the viewer detecting unit detects that a viewer is present in the near region, and adjusts the size of an image to be large when the viewer detecting unit does not detect that a viewer is present in the near region.

According to the present invention, the multi-display apparatus shows a large image on the display unit when a viewer is not present in the near region of the multi-display apparatus, while it shows a small image by reducing the number of displays used to show the image when a viewer is present in the near region. Accordingly, the multi-display apparatus shows an image with reduced size when a viewer comes closer, allowing the viewer to easily see and recognize the entire image.

In the multi-display apparatus according to the present invention, the image adjusting unit is capable of adjusting in at least two stages the size of an image showed on the display unit by increasing and reducing a number of displays used for image display on the display unit, adjusts the size of an image to be large when the viewer detecting unit detects that a viewer is present in the near region, and adjusts the size of an image to be small when the viewer detecting unit does not detect that a viewer is present in the near region.

According to the present invention, the multi-display apparatus shows a large image on the display unit when a viewer is present in the near region of the multi-display apparatus, and shows a small image by reducing the number of displays used for showing the image when no viewer is present in the near region. Thus, the multi-display apparatus stops display of the image on a part of the displays when there is no viewer who is watching the image.

In the multi-display apparatus according to the present invention, the image adjusting unit shows, while one image is showed using plural displays by the display unit, a small image with the same content as the one image on the display unit using a display or displays less in number than the plural displays, when the viewer detecting unit detects that a viewer is present in the near region.

According to the present invention, the multi-display apparatus shows a small image with the same content as the image currently being showed on the display unit, the small image overlaying the currently-showed image, when a viewer is present in the near region of the multi-display apparatus. The viewer who has approached the multi-display apparatus can specifically see the small image, while the viewer who is at a distant place outside the near region can keep watching the large image being showed on the display unit.

In the multi-display apparatus according to the present invention, the viewer detecting unit detects a position of a viewer in the near region, and the image adjusting unit selects a display located near the detected position of the viewer as a display used for showing the small image.

According to the present invention, the multi-display apparatus detects the position of a viewer when the viewer is present in the near region of the multi-display apparatus, and shows on a display located near the viewer a small image with the same contents as the image currently being showed on the display unit, the small image overlaying the currently-showed image. The viewer who has approached the multi-display apparatus can see the small image in detail.

The multi-display apparatus according to the present invention further comprises a clock unit, wherein the image adjusting unit selects between execution and non-execution of a function in accordance with date and time monitored by the clock unit.

According to the present invention, the multi-display apparatus selects operating and non-operating of a function of adjusting the size of the image showed on the display unit based on whether or not a viewer is present in the near region of the multi-display apparatus. In a state where the number of unidentified viewers increases and decreases depending on date and time, the multi-display apparatus can perform operations in accordance with the number of viewers.

In the multi-display apparatus according to the present invention, the viewer detecting unit includes: a capture unit; a face detecting unit that detects a human face facing a display surface of the display unit from an image of an outside captured by the capture unit; and a viewer presence determining unit that determines whether or not a viewer is present in the near region based on a size and/or a position of the face in the image, when the face detecting unit detects the face.

According to the present invention, the multi-display apparatus captures an image of the outside and detects a human face facing the display unit, to detect a viewer who is watching the image showed on the display unit. Moreover, the multi-display apparatus calculates a distance from the display unit to the viewer based on the position or size of the detected face, to detect whether or not a viewer is present in the near region of the multi-display apparatus.

According to the present invention, the multi-display apparatus can adjust the method of showing an image such that the image is made small for a viewer to easily see when the viewer is at a close position, or the number of displays showing an image is reduced when no viewer is watching the image. This enhances the convenience for viewers depending on a status of use by unidentified viewers, producing beneficial effects.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram illustrating a configuration of a multi-display apparatus according to Embodiment 1;

FIGS. 2A-2B are schematic views illustrating examples of images captured by a capture unit;

FIG. 3 is a flowchart illustrating a procedure of a process by which a multi-display apparatus according to Embodiment 1 adjusts the size of an image;

FIGS. 4A-4B are schematic views illustrating examples of images showed on a display unit;

FIG. 5 is a flowchart illustrating a procedure of a process by which a multi-display apparatus according to Embodiment 2 adjusts the size of an image;

FIG. 6 is a flowchart illustrating a procedure of a process by which a multi-display apparatus according to Embodiment 3 adjusts the size of an image;

FIG. 7 is a schematic view illustrating an example of an overlay display of an image;

FIG. 8 is a flowchart illustrating a procedure of a process by which a multi-display apparatus according to Embodiment 4 adjusts the size of an image;

FIGS. 9A-C are schematic views illustrating examples of overlay displays;

FIG. 10 is a schematic diagram illustrating a method of detecting a position of a viewer using distance sensors;

FIG. 11 is a schematic diagram illustrating an example of a near region;

FIG. 12 is a block diagram illustrating a configuration of a multi-display apparatus according to Embodiment 5; and

FIG. 13 is a schematic diagram illustrating an example of setting stored in a setting storing unit.

### DETAILED DESCRIPTION

The present invention will specifically be described with reference to drawings illustrating the embodiments thereof.

### Embodiment 1

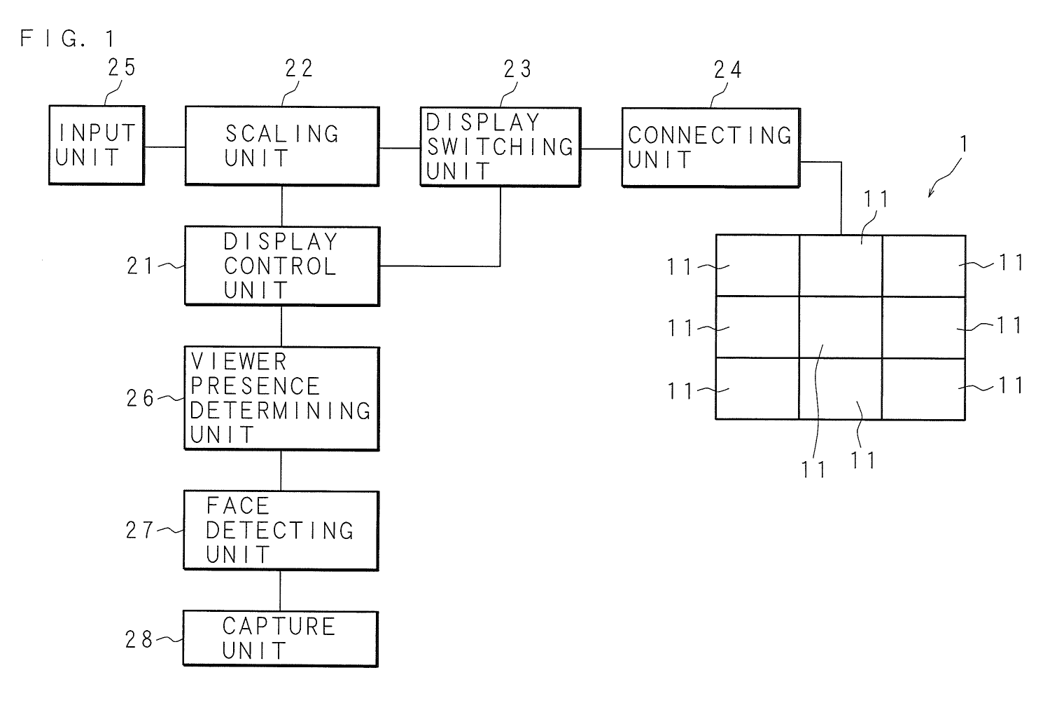

FIG. 1 is a block diagram illustrating a configuration of a multi-display apparatus according to Embodiment 1. The multi-display apparatus is an information display which is installed in a store, public space or the like to show an image representing various types of information such as guidance of a facility, explanation of exhibits, news, advertisement and the like. The multi-display apparatus includes a display unit 1 constituted by a plurality of displays 11, 11, . . . . The display 11 is an image displaying unit such as a liquid-crystal display, plasma display or the like, and is formed to have a rectangular shape. The display unit 1 is configured by a plurality of displays 11, 11, arranged vertically and horizontally, which are combined together to form an enormous rectangular display. Assume that the display unit 1 is constituted by M displays 11 in a vertical line and N displays 11 in a horizontal line. This means that the display unit 1 includes M×N displays 11.

Display unit 1 is connected to a connecting unit 24 which is an output interface for an image signal. Each display 11 is individually connected to the connecting unit 24. Note that the display unit 1 is so configured that one display 11 is connected to the connecting unit 24 while a plurality of displays 11, 11, . . . are connected to the connecting unit 24 in the form of a daisy-chain connection in which a plurality of displays 11, 11, . . . are connected in series.

The multi-display apparatus includes an input unit 25 to which image data is input from the outside, a scaling unit 22 that adjusts the size of an image represented by the image data, and a display switching unit 23 that switches display 11 on which the image whose size has been adjusted is showed. For example, when resolution of the display 11 corresponds to A in a vertical line and B in a horizontal line, the scaling unit 22 performs scaling on an image such that the resolution of the image corresponds to AM in the vertical line and BN in the horizontal line, and divides the scaled image into M×N images. The display switching unit 23 performs a process of making each of M×N displays 11 connected to the connecting unit 24 show any one of the M×N images. Each display 11 shows each of M×N images which are a part of the image scaled to have resolution of AM vertically and BN horizontally, so that the display unit 1 shows, using M×N displays 11, an image M times vertically and N times horizontally larger than each display 11. The display unit 1 thus shows an image larger than each display 11. To the scaling unit 22 and display switching unit 23, a display control unit 21 that controls operations thereof is connected. The multi-display apparatus may be configured to store image data therein and show an image based on the stored image data, instead of showing an image based on image data input from the outside. The display control unit 21, scaling unit 22 and display switching unit 23 correspond to an image adjustment unit.

Moreover, the multi display apparatus includes a capture unit 28 that captures an image of the outside. The capture unit 28 includes an image pickup device such as a Charge Coupled Device (CCD) image sensor, which generates a captured image of the outside. The capture unit 28 is arranged at a position where a face of a viewer facing a display surface of the display unit 1 can be captured. For example, the capture unit 28 is arranged at the upper, lower, left and right sides of the display unit 1, or at the frame portion of the display 11. To the capture unit 28, a face detecting unit 27 is connected that performs a process of detecting a face of a human being included in the captured imaged generated by the capture unit 28. The face detecting unit 27 uses a conventional technique to detect a human face. For example, the face detecting unit 27 extracts a region with a color similar to a skin color in the captured image, determines whether or not a graphic form of a shape characteristic for a human face such as eyes, eyebrows and a mouth, and determines that a human face is detected if such a graphic form of the characteristic shape. In addition, the face detecting unit 27, for example, determines whether or not the extracted region corresponds to a certain size or larger, and determines that a human face is detected if the extracted region has a certain size or larger. By the face detecting unit 27 detecting a human face, the multi-display apparatus detects a person whose face is directed to the display surface of the display unit 1, i.e., a viewer who is watching the image showed by the display unit 1.

To the face detecting unit 27, a viewer presence determining unit 26 is connected that performs a process of determining a presence of a viewer. If a human face is detected, the face detecting unit 27 outputs a signal indicating that a human face is detected to the viewer presence determining unit 26. The viewer presence determining unit 26 determines whether or not a viewer is present in a region near the multi-display apparatus (hereinafter referred to as a “near region”). The near region is an area where a distance from a viewer to the display surface of the display unit 1 is not more than a predetermined distance.

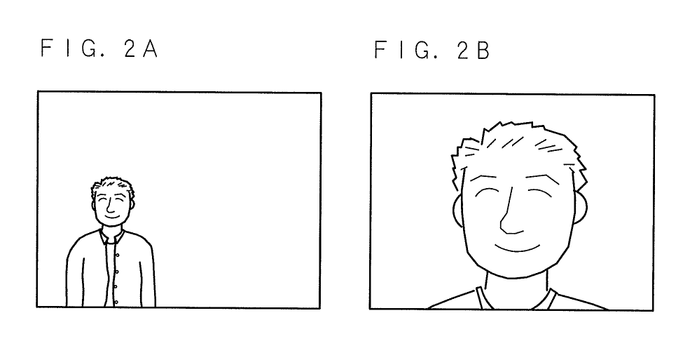

FIGS. 2A and 2B are schematic views illustrating examples of images captured by the capture unit 28. FIG. 2A shows an example of an image captured when a viewer stays outside the near region. The face detecting unit 27 detects a human face from the captured image to detect a viewer. Since the viewer who stays away from the display unit 1 is far from the capture unit 28, the area of the face occupying the captured image is small. FIG. 2B shows an example of an image captured when a viewer stays in the near region. As the viewer comes closer to the display surface of the display unit 1, the viewer is closer to the capture unit 28, increasing the area of the face in the captured image as shown in FIG. 2B. Once the area of the face in the captured image is equal to or larger than a predetermined size, the viewer presence determining unit 26 determines that a viewer is present in the near region. Furthermore, if the viewer is far away, the face of the viewer is located around the edge of the captured image, and moves toward a certain portion such as a middle part of the captured image as the viewer comes closer. Thus, the viewer presence determining unit 26 determines that a viewer is present in the near region, if, for example, the face of the viewer is in a predetermined portion in the captured image. Moreover, the viewer presence determining unit 26 may determine that the viewer is present in the near region when the face of a human can be seen at a certain position in the captured image and the size of the area corresponding to the face is larger than a specific area corresponding to the certain position. Accordingly, the multi-display apparatus detects that a viewer is present in the near region. The multi-display apparatus determines that the viewer is present in the near region to detect that the viewer has approached the display surface of the display unit 1. It is noted that the multi-display apparatus may determine whether or not the viewer is present in the near region in accordance with the detection result indicating whether or not a human face has been detected by the face detecting unit 27.

The viewer presence determining unit 26 is connected to the display control unit 21. The viewer presence determining unit 26 outputs a signal, indicating a determined result that shows whether a viewer is present, to the display control unit 21. Furthermore, if the face detecting unit 27 does not detect a human face, the viewer presence determining unit 26 outputs a signal, indicating that no presence of a viewer has been detected, to the display control unit 21. The display control unit 21 controls the operations of the scaling unit 22 and display switching unit 23 based on the determined result indicated by the signal from the viewer presence determining unit 26, to adjust the size of an image showed on the display unit 1.

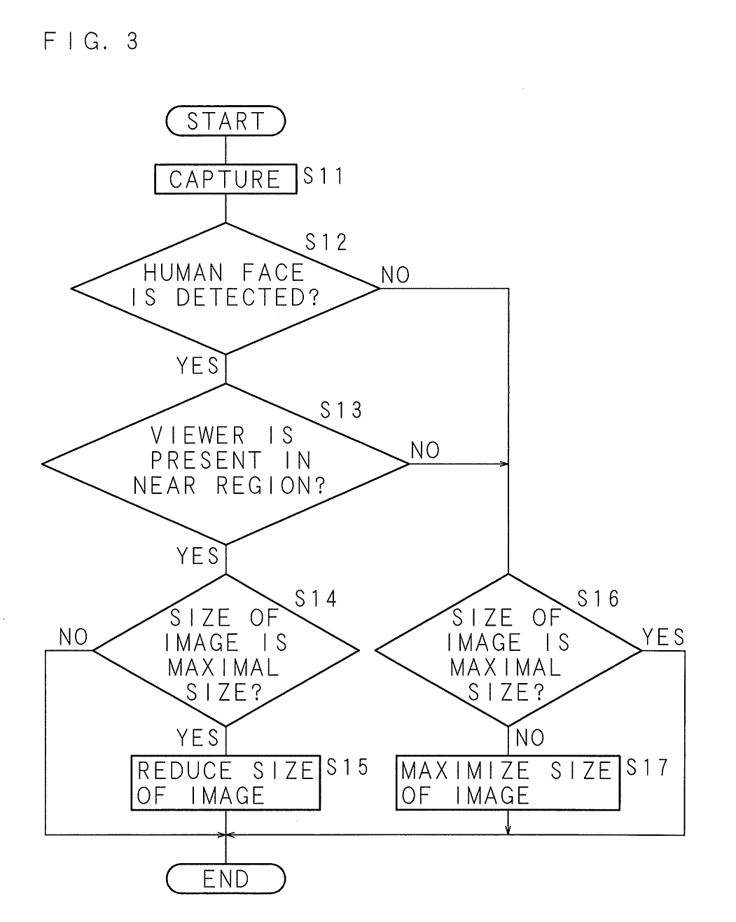

Next, the operation of the multi-display apparatus is described. The multi-display apparatus according to the present invention performs a process of adjusting the size of an image showed on the display unit 1 in accordance with the presence/absence of a viewer. FIG. 3 is a flowchart illustrating a procedure of a process by which a multi-display apparatus in Embodiment 1 adjusts the size of an image. While the display unit 1 is showing an image, the capture unit 28 captures an image of the outside (S11), and the face detecting unit 27 determines whether or not a human face is detected in the captured image (S12). If the face detecting unit 27 detects a human face in the captured image (YES at S12), the viewer presence determining unit 26 determines whether or not a viewer is present in the near region of the multi-display apparatus (S13). If the viewer presence determining unit 26 determines that a viewer is present in the near region of the multi-display apparatus (YES at S13), the display control unit 21 determines whether or not the size of the image showed on the display unit 1 is a maximal size (S14).

The state in which the size of the image is at maximum means that the image is showed by the display unit 1 using M×N displays 11. More specifically, when the resolution of the display 11 corresponds to A in the vertical direction and B in the horizontal direction, the scaling unit 22 scales the image such that the resolution of the image is AM vertically and BN horizontally and divides the scaled image into M×N images. The display switching unit 23 shows each of the M×N images on each display 11. If the size of the image is not at maximum, the display unit 1 shows the image using m×n displays 11, smaller in number than M×N. Here, the scaling unit 22 scales the image such that the resolution of the image is Am vertically and Bn horizontally, and divides the scaled image into m×n images. The display switching unit 23 shows each of the m×n images on neighboring m×n displays 11. Moreover, no image is showed here on display 11 other than the m×n displays 11. The display control unit 21 determines the size of the image currently showed on the display unit 1 based on the controlled matter for the scaling unit 22 and display switching unit 23.

If the size of the image is at maximum at step S14 (YES at S14), the display control unit 21 reduces the size of the image to be smaller than the maximal size by controlling the operations of the scaling unit 22 and display switching unit 22 such that the display unit 1 uses m×n displays 11 to show an image (S15). After step S15 is completed, the display control unit 21 terminates the process of adjusting the size of the image. If the size of the image is not at maximum at step S14 (NO at S14), the display control unit 21 terminates the process while maintaining the size of the image.

If the face detecting unit 27 cannot detect a human face in a captured image at step S12 (NO at S12), or if the viewer presence determining unit 26 determines that no viewer is present in the near region (NO at 513), the display control unit 21 determines whether or not the size of the image being showed on the display unit 1 is at maximum (S16). If the size of the image is at maximum (YES at S16), the display control unit 21 terminates the process while the size of the image is maintained at maximum. If the size of the image is not at maximum at step S16 (NO at S16), the display control unit 21 controls the operations of the scaling unit 22 and display switching unit 23 to maximize the size of the image showed on the display unit 1 (S17). After step S17 is completed, the display control unit 21 terminates the process of adjusting the size of the image. The multi-display apparatus regularly repeats the processing from steps S11 to S17.

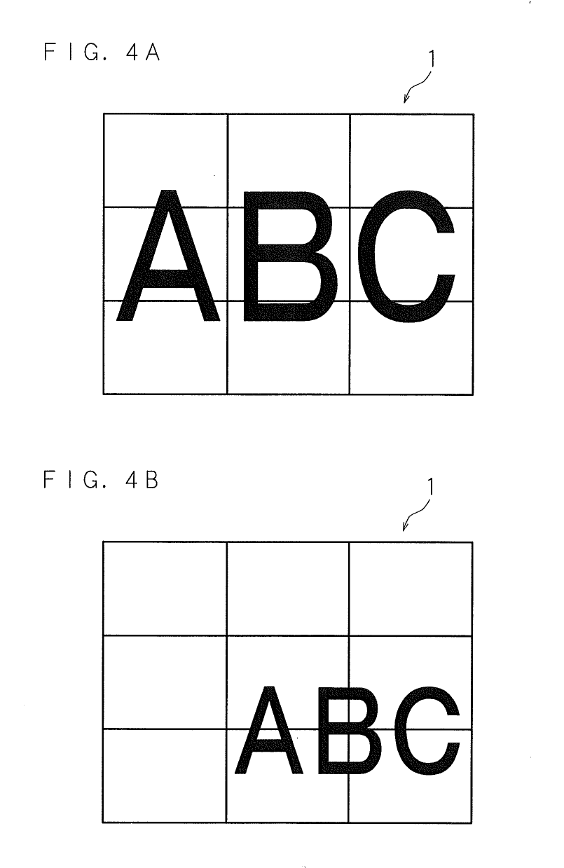

FIGS. 4A and 4B are schematic views illustrating examples of images showed on the display unit 1. FIG. 4A shows an example in which the size of the image is maximized using three by three displays 11 arranged in vertical and horizontal directions, respectively. FIG. 4B shows an example in which the size of the image is reduced to be a size using two by two displays 11 arranged in vertical and horizontal directions, respectively. While there are four ways of selecting two by two displays 11, the displays 11 to be used when the size of the image is reduced have been set in advance. The image showing position that can easily be seen by a viewer changes depending on the installation condition of the display unit 1. Hence, the multi-display apparatus is configured such that the display 11 used in reducing the size of image can be changed.

As described above, the multi-display apparatus shows a small image on the display unit 1 when a viewer watching the image showed on the display unit 1 is present in the near region of the multi-display apparatus. In other words, a small image is showed when an unidentified viewer approaches the display surface of the display unit 1. The whole display unit 1 may not fall in the sight of a viewer when the viewer is close to the display surface of the display unit 1. It is easier for the viewer to see the whole image and to recognize the content of image when some of the displays 11 in the display unit 1 are used to show a small image.

Furthermore, in the present embodiment, the multi-display apparatus maximizes an image showed on the display unit 1 when an unidentified viewer is not present in the near region of the multi-display apparatus. By showing a large image on the display unit 1, it is easier to see the image from a distance, increasing the appeal power for a viewer who may be present at a distant location even if no viewer is present in the near region. This increases the opportunity for a viewer, who sees the image from a distance, to approach the display unit 1 and recognize the content of image, enhancing the use efficiency of the image.

Though the present embodiment illustrated an example where the size of an image is changed depending on the presence/absence of a viewer in the near region of the multi-display apparatus, the multi-display apparatus may alternatively change the size of image when a viewer moving toward or away from the display is detected. The multi-display apparatus can detect that a viewer is approaching by detecting a change from the state where no viewer is present in the near region to the state where the viewer is present in the near region. Moreover, the multi-display apparatus can detect that a viewer is moving away by detecting a change from the state where the viewer is present in the near region to the state where no viewer is present in the near region. Therefore, the multi-display apparatus executes a process similar to that in the present embodiment change the size of an image when approaching or moving away of a viewer is detected.

Though the present embodiment illustrated that the capture unit 28 is used to detect a viewer, the multi-display apparatus may alternatively detect a viewer using a sensor instead of the capture unit 28. For example, the multi-display apparatus may use an infrared sensor to detect a viewer, and use a distance sensor to measure the distance to the viewer, for detecting the presence of the viewer in the near region. The infrared sensor detects a viewer by a method of emitting infrared ray and receiving the infrared ray reflected at a human body, or a method of detecting infrared ray emitted from a human body. Moreover, the distance sensor emits ultrasonic or electric wave and receives the ultrasonic or electric wave reflected at a human body to measure the distance from the human body. Multi-display apparatus includes an infrared sensor and a distance sensor instead of the capture unit 28 and face detecting unit 27. Furthermore, the multi-display apparatus performs a process of detecting a viewer based on the result detected by the infrared sensor in place of steps S11 and S12, and determines whether or not a viewer is present in the near region based on the result measured by the distance sensor at step S13. In this configuration also, the multi-display apparatus shows an image of a small size when a viewer approaches the display surface of the display unit 1, to allow the viewer to easily see the image.

### Embodiment 2

In Embodiment 2, the multi-display apparatus adjusts the size of an image such that power consumption is reduced when no viewer is present. Since the internal configuration of the multi-display apparatus is similar to those in Embodiment 1, the explanation thereof will not be repeated here.

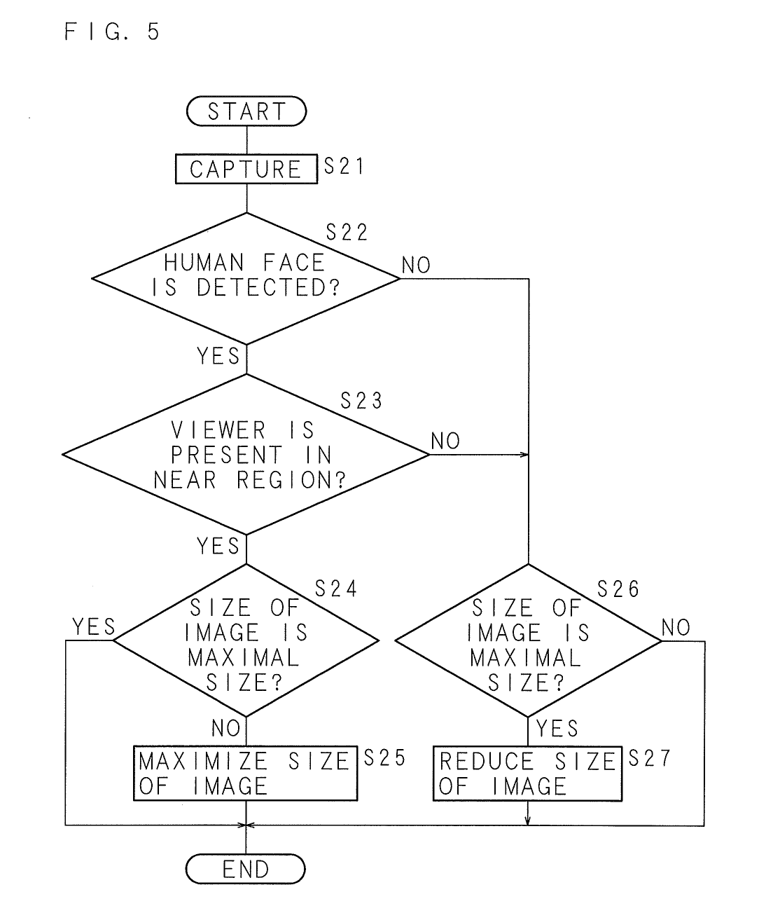

FIG. 5 is a flowchart illustrating a procedure of a process by which the multi-display apparatus according to Embodiment 2 adjusts the size of an image. While an image is being showed on the display unit 1, the capture unit 28 captures an image of the outside (S21), and the face detecting unit 27 determines whether or not a human face is detected in the captured image (S22). If the face detecting unit 27 detects a human face (YES at S22), the viewer presence determining unit 26 determines whether or not a viewer is present in the near-filed region of the multi-display apparatus (S23). If the viewer presence determining unit 26 determines that a viewer is present in the near region (YES at S23), the display control unit 21 determines whether or not the image being showed on the display unit 1 has a maximal size (S24). If the size of the image is at maximum (YES at S24), the display control unit 21 terminates the processing while the size of image is maintained at maximum. If the size of image is not at maximum at step S24 (NO at S24), the display control unit 21 controls the operations of scaling unit 22 and display switching unit 23 such that the display unit 1 shows an image using M×N displays 11, in order to maximize the size of the image (S25). After completing step S25, the display control unit 21 terminates the process of adjusting the size of image.

If the face detecting unit 27 cannot detect a human face at step S22 (NO at step S22), or if the viewer presence determining unit 26 determines that no viewer is present in the near region at step S23 (NO at S23), the display control unit 21 determines whether or not the size of the image being showed on the display unit 1 is at maximum (S26). If the size of the image is at maximum (YES at S26), the display control unit 21 controls the operations of scaling unit 22 and display switching unit 23 such that the display unit 1 shows an image using m×n displays 11, in order to reduce the size of the image to be smaller than the maximal size (S27). After completing step S27, the display control unit 21 terminates the process of adjusting the size of image. If the size of the image is not at maximum at step S26 (NO at S26), the display control unit 21 terminates the process while the size of the image is maintained to be small.

The multi-display apparatus according to the present embodiment regularly repeats the processing of steps S21 to S27. The processing described above allows the multi-display apparatus to show a large image on the display unit 1 when a viewer who is watching an image showed on the display unit 1 is present in the near region of the multi-display apparatus. That is, a large image is showed when an unidentified viewer conies close to the display surface of the display unit 1, allowing the viewer to recognize the content of the image in detail. Moreover, the multi-display apparatus shows a small image on the display unit 1 when no viewer is present in the near region of the multi-display apparatus. That is, when no viewer is watching the image showed on the display unit 1, a small image is showed by some of the displays 11 of the display unit 1 while no image is showed by the other displays 11. Accordingly, the multi-display apparatus stops showing of an image on a part of the displays 11 when no viewer is watching the image, enabling reduction in power consumption.

It is noted that the present embodiment is opposite to Embodiment 1 as to the processing contents, and is different from Embodiment 1 in the setting of a predetermined distance from the display surface of the display unit 1 to a viewer, which corresponds to a boundary for the near region. In the present embodiment, the predetermined distance is longer and the near region is wider compared to those in Embodiment 1. Since a viewer within the near region is a certain distance away from the display surface of the multi-display unit 1, the viewer can easily recognize the whole image even if the image showed is large. Furthermore, the multi-display apparatus according to the present embodiment may take a form of as in Embodiment 1, using an infrared sensor to detect a viewer and using a distance sensor to detect that the viewer is present in the near region.

### Embodiment 3

In Embodiment 3, it is illustrated that a multi-display apparatus shows an image with overlay display for both nearby and distant viewers to easily see the image. Since the multi-display apparatus has an internal configuration similar to that in Embodiment 1, the description thereof will not be repeated here.

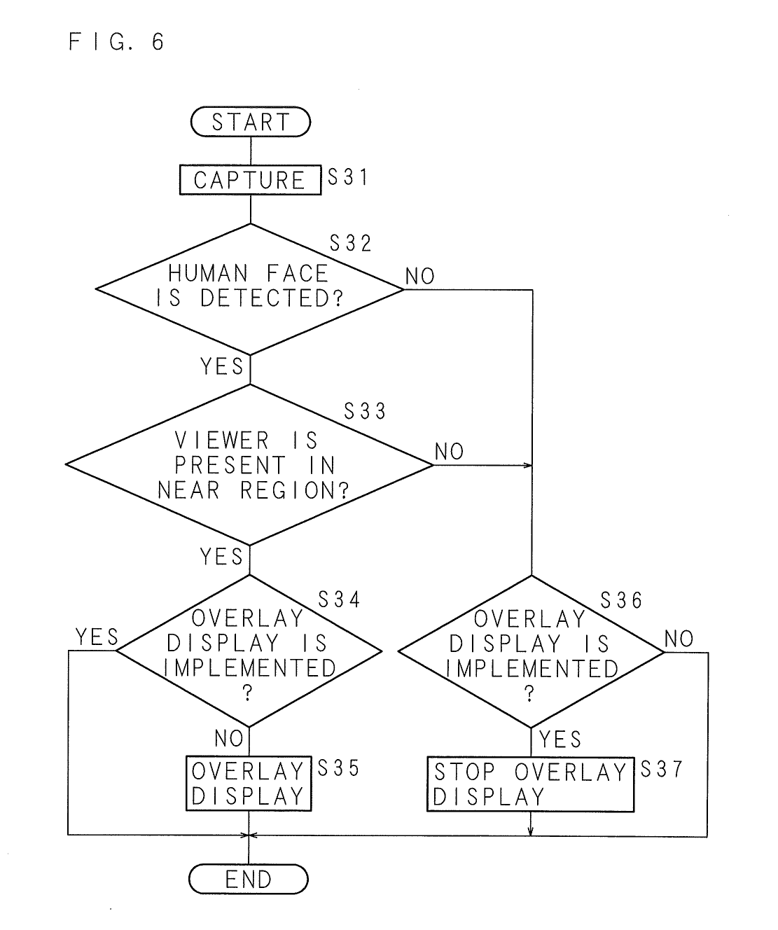

FIG. 6 is a flowchart illustrating a procedure of a process by which a multi-display apparatus according to Embodiment 3 adjusts the size of an image. The capture unit 28 captures an image of the outside while the display unit 1 is showing the image (S31), and the face detecting unit 27 determines whether or not a human face is detected in the captured image (S32). If the face detecting unit 27 detects a human face (YES at S32), the viewer presence determining unit 26 determines whether or not a viewer is present in the near region of the multi-display apparatus (S33). If the viewer presence determining unit 26 determines that a viewer is present in the near region (YES at S33), the display control unit 21 determines whether or not an overlay display is implemented in which an image with the maximal size showed on the display unit 1 is overlaid by the same image with a smaller size (S34). If the overlay display is not implemented (NO at S34), the display control unit 21 activates the overlay display in which an image with the same content as but with a size smaller than the currently-showed image is showed overlaying the image currently showed on the display unit 1 (S35). At step S35, the display control unit 21 implements overlay display by controlling the operations of scaling unit 22 and display switching unit 23 such that the display or displays 11 of a number smaller than M×N are used to show a small image overlaying the currently-showed image.

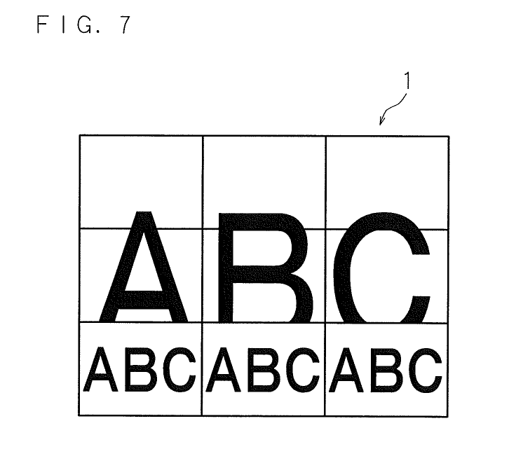

FIG. 7 is a schematic view illustrating an example of an overlay display of an image. An image with the maximal size is showed using three times three vertical and horizontal displays 11, while a small image with the same content and smaller size is showed on each of the three displays 11 at the lower part. A part of the maximal image is covered by the overlaid small image. It is noted that, though an example where three small images are showed is illustrated in FIG. 7, the multi-display apparatus may show one small image on the display unit 1. Moreover, though FIG. 7 illustrates an example where one display 11 is used to show a small image, the multi-display apparatus may show one small image using plural displays 11. Furthermore, the display(s) 11 used for showing a small image is/are set in advance. The display 11 for showing a small image is preferably the display 11 at the same height as the eye level of a viewer who has approached the display surface of the display unit 1.

After completing step S35, the display control unit 21 terminates the process of adjusting the size of an image. When the overlay display is implemented at step S34 (YES at S34), the display control unit 21 terminates the processing while maintaining the overlay display of the image.

If the face detecting unit 27 cannot detect a human face at step S32 (NO at S32), or if the viewer presence determining unit 26 determines that no viewer is present in the near region at step S33 (NO at step S33), the display control unit 21 determines whether or not overlay display is implemented on the display unit 1 (S36). If the overlay display is implemented (YES at S36), the display control unit 21 controls the operations of scaling unit 22 and display switching unit 23 to stop the overlay display (S37). By step S37, only an image with the maximal size is showed on the display unit 1. After completing step S37, the display control unit 21 terminates the process of adjusting the size of image. If, at step S36, overlay display is not implemented (NO at S36), the display control unit 21 terminates the process of adjusting the size of image. The multi-display apparatus according to the present embodiment regularly repeats the processing at the steps S31 to S37.

As described above in detail, the multi-display apparatus displays a small image overlaying and showing the same content as the currently-showed image, when a viewer watching the image showed on the display unit 1 is present in the near region of the multi-display apparatus. That is, when an unidentified viewer approaches the display surface of the display unit 1, a small image is overlaid to be showed on the currently-showed image. By watching the small image, it is easy for the viewer who has approached the display unit 1 to see the whole image and to recognize the content of the image. Moreover, a large image is still being showed, though a part thereof is covered by the small image. Therefore, a viewer at a distance can easily see the image while the appeal power of the image to an unidentified viewer who may be present at a distant place is maintained. As such, the multi-display apparatus shows an image for both a nearby viewer and a distant viewer to easily see the image.

It is noted that the multi-display apparatus according to the present embodiment may, as in Embodiment 1, use an infrared sensor to detect a viewer and may use a distance sensor to detect that the viewer is present in the near region. The multi-display apparatus according to the present embodiment may perform, in addition to the process of showing a small image, the process of changing the size of an image as illustrated in Embodiment 1 or 2, when a viewer is present in the near region.

### Embodiment 4

Embodiment 4 illustrates that the multi-display apparatus adjusts the position of a small image in accordance with the position of a viewer in the near region. Since the multi-display apparatus has an internal configuration similar to that in Embodiment 1, the description thereof will not be repeated here.

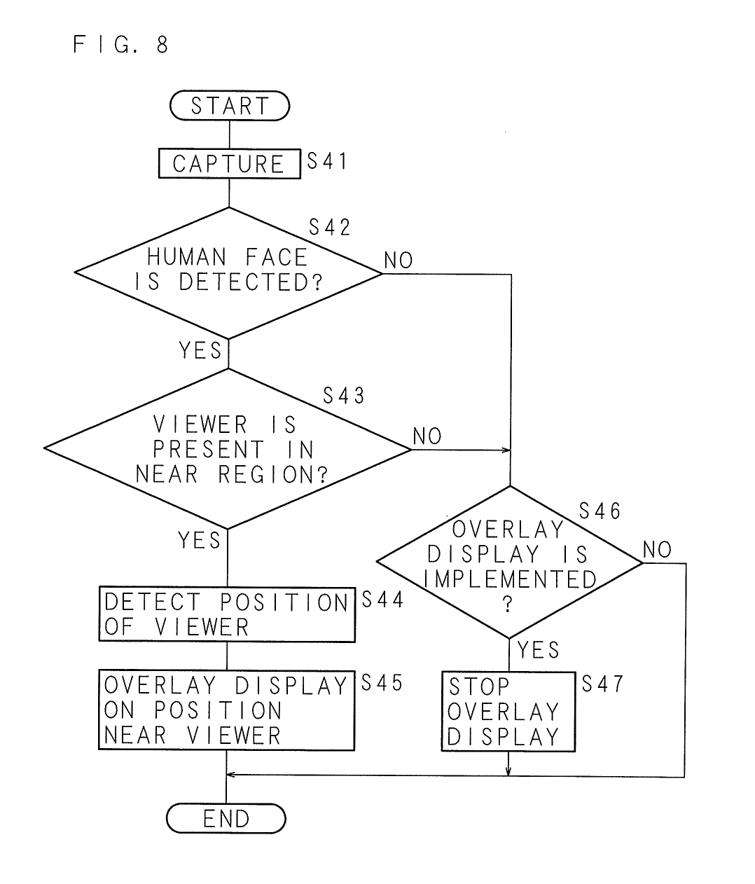

FIG. 8 is a flowchart illustrating a procedure of a process by which a multi-display apparatus according to Embodiment 4 adjusts the size of an image. While the display unit 1 is showing an image, the capture unit 28 captures an image of the outside (S41), and the face detecting unit 27 determines whether or not a human face is detected in the captured image (S42). If the face detecting unit 27 detects a human face (YES at S42), the viewer presence determining unit 26 determines whether or not a viewer is present in the near region of the multi-display apparatus (S43). If it is determined that a viewer is present in the near region (YES at S43), the viewer presence determining unit 26 detects the position of the viewer in the near region based on the position of the face in the captured image (S44).

At step S44, when, for example, the face is positioned at the central part in the horizontal direction in the captured image, the viewer presence determining unit 26 determines that the position of the viewer is in front of the central part of the display unit 1. Moreover, when the face is positioned at the right side in the horizontal direction in the captured image, the viewer presence determining unit 26 determines that the position of the viewer is in front of the left side of the display unit 1 when viewed from the viewer's side. Furthermore, when the face is positioned at the left side in the horizontal direction in the captured image, the viewer presence determining unit 26 determines that the position of the viewer is in front of the right side of the display unit 1 when viewed from the viewer's side.

The display control unit 21 controls the operations of the scaling unit 22 and display switching unit 23 such that the display 11 located the closest to the detected position of the viewer shows a small image, for the overlay display of the image (S45). After completing step S45, the display control unit 21 terminates the process of adjusting the size of the image.

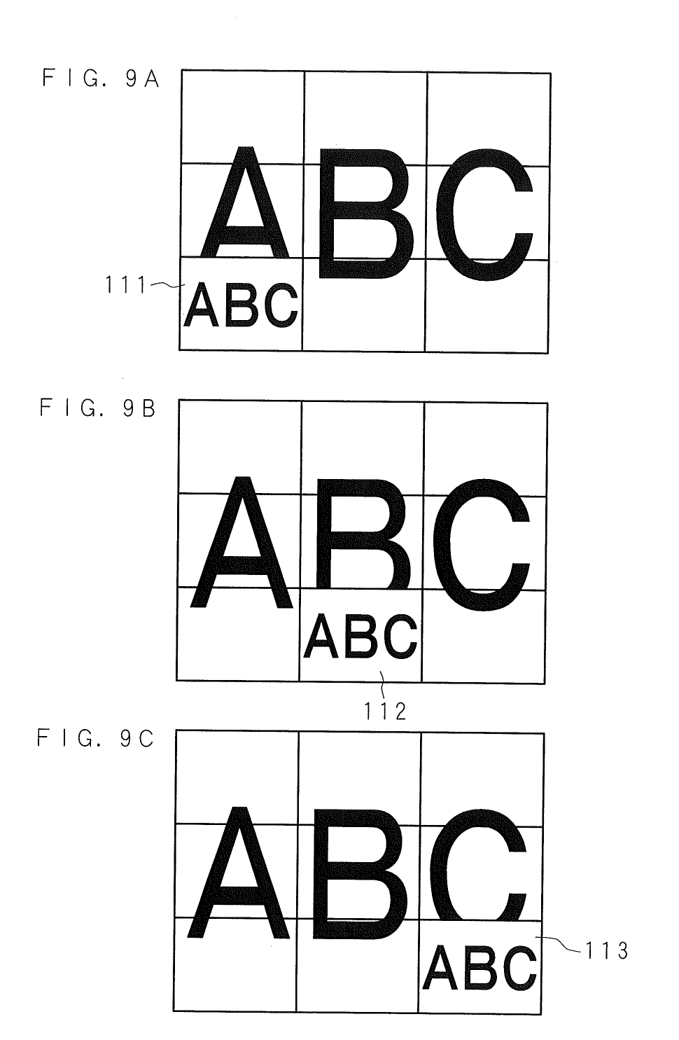

FIGS. 9A, 9B and 9C are schematic views illustrating examples of overlay displays. FIG. 9A shows an example of an overlay display implemented when a viewer is in front of the left side of the display unit 1 when viewed from the viewer's side. Among the plural displays 11, the display 11 located at the closest to the viewer, i.e., a display 111 located at the lower-left part of the display unit 1, shows a small image. FIG. 9B shows an example of an overlay display implemented when a viewer is in front of the central part of the display unit 1 when viewed from the viewer's side. The display 11 located at the closest to the viewer, i.e., a display 112 located at the lower-central part of the display unit 1 shows a small image. FIG. 9C shows an example of an overlay display implemented when a viewer is in front of the right side of the display unit 1 when viewed from the viewer's side. Among the plural displays 11, the display 11 located at the closest to the viewer, i.e., a display 113 located at the lower-right part of the display unit 1 shows a small image.

If the face detecting unit 27 cannot detect a human face at step S42 (NO at S42), or if the viewer presence determining unit 26 determines that no viewer is present in the near region at step S43 (NO at S43), the display control unit 21 determines whether or not the display unit 1 is implementing an overlay display (S46). If the overlay display is implemented (YES at S46), the display control unit 21 stops the overlay display (S47). After completing the process of step S47, the display control unit 21 terminates the process of adjusting the size of image. If the overlay display is not implemented at step S46 (NO at S46), the display control unit 21 terminates the process of adjusting the size of image. The multi-display apparatus according to the present embodiment regularly repeats the processing of steps S41 to S47.

It is noted that the display apparatus may use an infrared sensor to detect a viewer and may use a distance sensor to detect that the viewer is present in the near region. The processing of the multi-display apparatus using the distance sensor will be described below. The multi-display apparatus of this configuration performs a process of detecting a viewer based on the result detected by the infrared sensor, in place of steps S41 and S42. Moreover, the multi-display apparatus includes plural distance sensors, to determine whether or not a viewer is present in the near region at step S43 and to detect the position of the viewer at step S44, based on the result measured by the distance sensor.

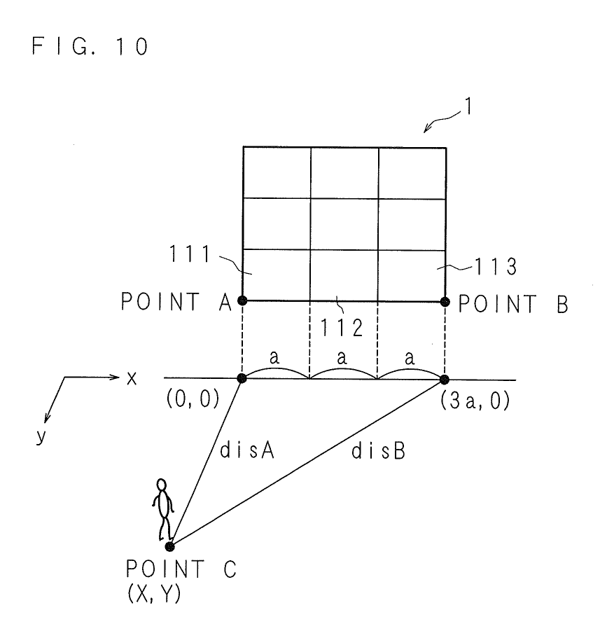

FIG. 10 is a schematic diagram illustrating a method of detecting a position of a viewer using distance sensors. Two distance sensors are respectively arranged at both sides of the display unit 1. Assume that the horizontal direction along the display surface of the display unit 1 is direction “x,” while the direction perpendicular to the display surface is direction “y.” Moreover, the width of each display 11 is set as “a.” Thus, the width of the display unit 1 consisting of three (vertical) times three (horizontal) displays 11 is 3a. If the left end of the lower-left display 111 is set as a point A (0, 0), the right end of the lower-right display 113 will be a point B (3a, 0). The position of the viewer is determined as a point C (X, Y). A distance disA from the point A to point C and a distance disB from the point B to point C are measured by the distance sensors arranged at both sides of the display unit 1. The coordinate (X, Y) for the point C is calculated by the two simultaneous equations below.

disA²=X²+Y²

disB²=(X−3a)²+Y²

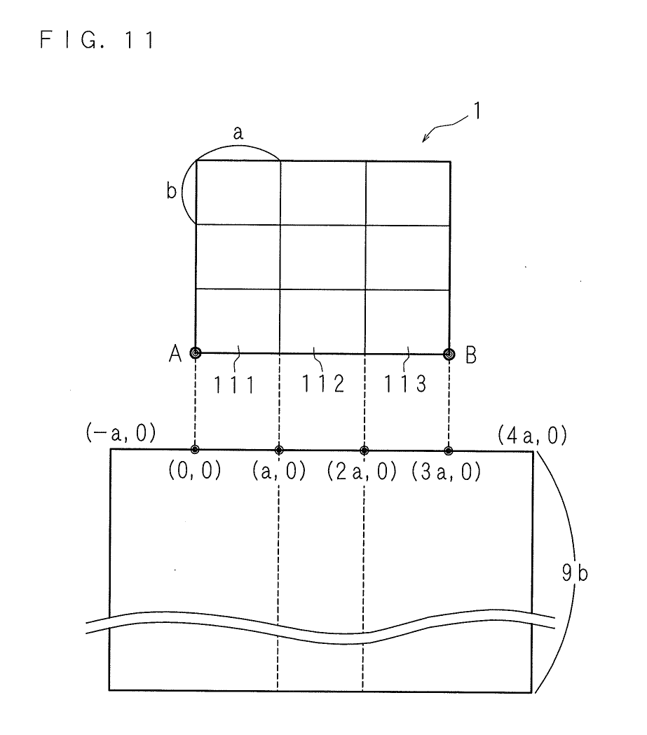

FIG. 11 is a schematic diagram illustrating an example of a near region. The multi-display apparatus determines, at step S43, whether or not a viewer is present in the near region based on whether or not the calculated value of Y is equal to or more than a predetermined distance. Generally, a position distant by three times the vertical direction from the display screen is considered to be the optimal viewing distance. Thus, for example, if the vertical length of each display 11 is b, the predetermined distance is set as 9b, which is three times the vertical length of the display unit 1. The multi-display apparatus determines, at step S43, that a viewer is present in the near region if Y is equal to or less than 9b, and determines that no viewer is in the near region if Y is larger than Ob. Furthermore, the multi-display apparatus also determines that no viewer is in the near region when X<−a and when X>4a.

The multi-display apparatus calculates the value of X to detect the position of a viewer at step S44, and implements an overlay display of an image on the display 11 in accordance with the value of X. More specifically, the multi-display apparatus shows a small image on the display 111 if −a≦X≦a, shows a small image on the display 112 if a≦X≦2a, and shows a small image on the display 113 if 2a<X≦4a.

As described above in detail, the multi-display apparatus shows a small image of the same content as the currently-showed image on, among the plural displays 11, the display 11 located at the closest to a viewer in the near region, the small image overlaying the image currently showed by the entire display unit 1. That is, when an unidentified viewer approaches the display surface of the display unit 1, a small image is shown by overlay display on the portion where the viewer has approached. For the viewer who has come close to the display unit 1, the small image is showed at a nearby position. This allows the viewer to easily see the small image and recognize the content of the image. Furthermore, as in Embodiment 3, the large image is still being showed on the display unit 1, maintaining the appeal power of the image to an unidentified viewer who may be present at a distant place.

It is noted that, also in the present embodiment, the multi-display apparatus may be configured, as in Embodiment 3, to perform a process of changing the size of image as described in Embodiment 1 or 2 in addition to the process of showing a small image, when a viewer is present in the near region.

### Embodiment 5

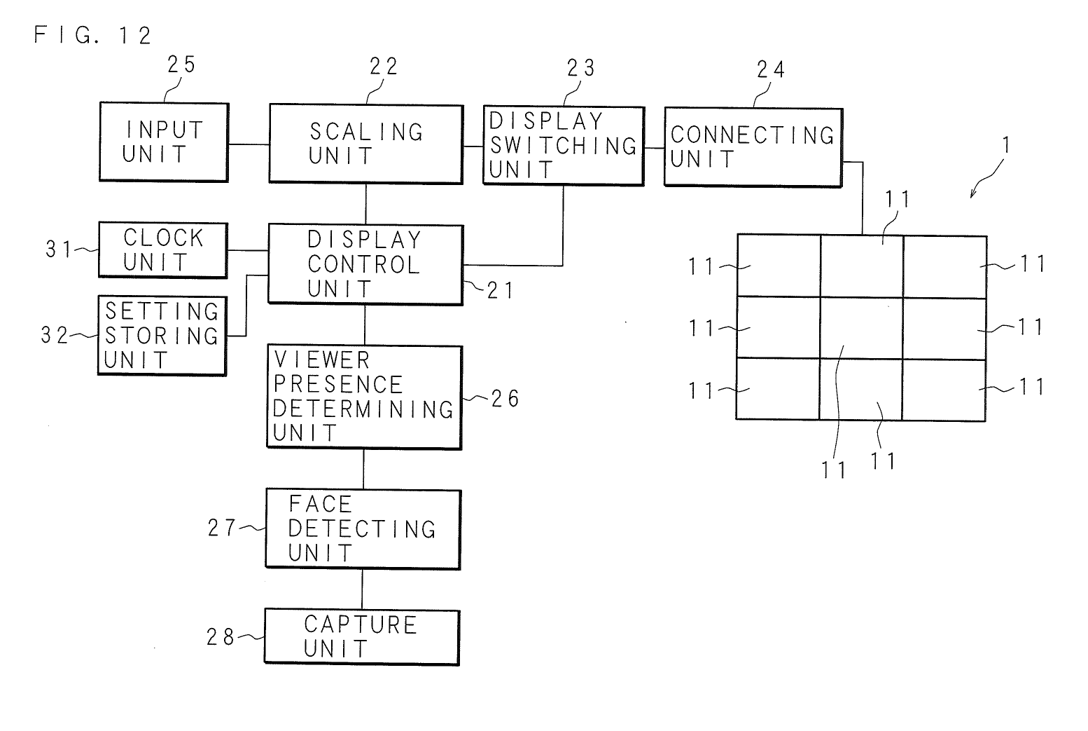

Embodiment 5 illustrates that the multi-display apparatus switches the function of adjusting the size of image in accordance with date and time. FIG. 12 is a block diagram illustrating a configuration of a multi-display apparatus according to Embodiment 5. In Embodiment 5, the multi-display apparatus includes a clock unit 31 that monitors date and time, the clock unit 31 being connected to the display control unit 21. The display control unit 21 performs a process of switching the function of adjusting the size of image in accordance with the date and time monitored by the clock unit 31. To the display control unit 21, a setting storing unit 32 that stores the setting details for switching the function of adjusting the size of image is also connected. Since the other configuration parts of the multi-display apparatus is similar to those in Embodiment 1, description thereof will not be described here.

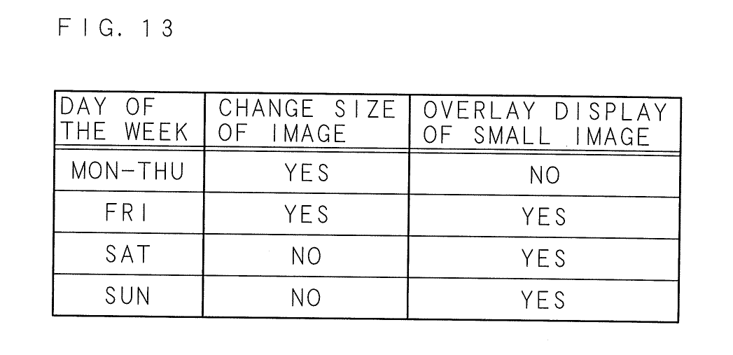

FIG. 13 is a schematic diagram illustrating an example of setting details stored in the setting storing unit 32. As an example for date and time, the days of the week are set. Setting is made for each day of the week as to whether or not the function of changing the size of image to be small by reducing the number of displays 11 that display an image on the display unit 1, as in Embodiment 1 or 2, is executed. Furthermore, in association with each day, as in Embodiment 3 or 4, setting is made as to whether or not the function of showing a small image by overlay display on any of the displays 11 in the display unit 1 is executed. The display control unit 21 performs a process of selecting execution and non-execution of the function of changing the size of the image to be small and/or the function of showing a small image by overlay display depending on the date and time monitored by the clock unit 31, in accordance with the setting stored in the setting storing unit 32.

In the example shown in FIG. 13, it is set that the function of reducing the size of image is executed, while the function of showing a small image by overlay display is not executed on Monday through Thursday. The multi-display apparatus installed in a place where a small number of people come and go on Mondays through Thursdays executes the function of reducing the size of image in accordance with the presence or absence of a viewer as in Embodiment 1 or 2, enabling reduction in power consumption. Furthermore, in the example illustrated in FIG. 13, the function of reducing the size of image and the function of showing a small image by overlay display are executed on Fridays. The multi-display apparatus installed in a place where a somewhat increased number of people come and go on Fridays executes both the function of reducing the size of image depending on presence or absence of a viewer and the function of showing a small image by overlay display, allowing an unidentified viewer to easily see the showed image. In the example illustrated in FIG. 13, on Saturdays and Sundays, setting is made such that the function of reducing the size of image is not executed but the function of showing a small image by overlay display is executed. The multi-display apparatus installed in a place where more people come and go on Saturdays and Sundays executes the function of showing a small image by overlay display depending on presence or absence of a viewer, allowing both a viewer in the near region and a viewer at a distant place to easily see the showed image.

It is noted that, in the present embodiment, the multi-display apparatus may select between execution and non-execution of the function of reducing the size of image and/or the function of showing a small image by overlay display depending on time, instead of days of the week. In such a case, the setting details stored in the setting storing unit 32 include whether or not the function of reducing the size of image and/or the function of showing a small image by overlay display in association with time is/are executed. The display control unit 21 performs a process of selecting between execution and non-execution of the function of reducing the size of image and/or the function of showing a small image by overlay display depending on time monitored by the clock unit 31 in accordance with the setting stored in the setting storing unit 32. For example, at midnight and in the early morning, the multi-display apparatus executes the function of reducing the size of an image depending on the presence or absence of a viewer, but does not execute the function of showing a small image by overlay display. Moreover, in the daytime at which a somewhat increased number of people come and go, the multi-display apparatus executes the function of reducing the size of image and the function of showing a small image by overlay display. Furthermore, the time from evening to night at which the place becomes crowded with viewers who have time to spare, the multi-display apparatus does not execute the function of reducing the size of image but executes the function of showing a small image by overlay display.

In Embodiments 1 to 5 described above, the multi-display apparatus includes information processing circuits such as the scaling unit 22 and display switching unit 23 to execute the processing according to the present invention. The multi-display apparatus in the present invention may, however, have a configuration in that software is employed to implement a part of the functions of these information processing circuits.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A multi-display apparatus showing an image using plural displays, comprising:
a display unit that includes a plurality of displays and shows an image larger than each display by showing on each of the plurality of displays a part of the image;
a viewer detecting unit that detects that a viewer is present in a near region of the display unit; and
an image adjusting unit that shows on the display unit an image with a size adjusted in accordance with a result detected by the viewer detecting unit.

2. The multi-display apparatus according to claim 1, wherein said image adjusting unit is capable of adjusting in at least two stages the size of an image showed on the display unit by increasing and reducing the number of displays used for image display on the display unit, adjusts the size of an image to be small when said viewer detecting unit detects that a viewer is present in said near region, and adjusts the size of an image to be large when said viewer detecting unit does not detect that a viewer is present in said near region.

3. The multi-display apparatus according to claim 1, wherein said image adjusting unit is capable of adjusting in at least two stages the size of an image showed on the display unit by increasing and reducing the number of displays used for image display on the display unit, adjusts the size of an image to be large when said viewer detecting unit detects that a viewer is present in said near region, and adjusts the size of an image to be small when said viewer detecting unit does not detect that a viewer is present in said near region.

4. The multi-display apparatus according to claim 1, wherein said image adjusting unit shows, while one image is showed using a plurality of displays by said display unit, a small image with a same content as said one image on said display unit using a display or displays less in number than said plurality of displays, when said viewer detecting unit detects that a viewer is present in said near region.

5. The multi-display apparatus according to claim 2, wherein said image adjusting unit shows, while one image is showed using a plurality of displays by said display unit, a small image with a same content as said one image on said display unit using a display or displays less in number than said plurality of displays, when said viewer detecting unit detects that a viewer is present in said near region.

6. The multi-display apparatus according to claim 3, wherein said image adjusting unit shows, while one image is showed using a plurality of displays by said display unit, a small image with a same content as said one image on said display unit using a display or displays less in number than said plurality of displays, when said viewer detecting unit detects that a viewer is present in said near region.

7. The multi-display apparatus according to claim 4, wherein said viewer detecting unit detects a position of a viewer in said near region, and
said image adjusting unit selects a display located near the detected position of the viewer as a display used for showing said small image.

8. The multi-display apparatus according to claim 5, wherein said viewer detecting unit detects a position of a viewer in said near region, and
said image adjusting unit selects a display located near the detected position of the viewer as a display used for showing said small image.

9. The multi-display apparatus according to claim 6, wherein said viewer detecting unit detects a position of a viewer in said near region, and
said image adjusting unit selects a display located near the detected position of the viewer as a display used for showing said small image.

10. The multi-display apparatus according to claim 1, further comprising a clock unit, wherein said image adjusting unit selects between execution and non-execution of a function in accordance with date and time monitored by said clock unit.

11. The multi-display apparatus according to claim 2, further comprising a clock unit, wherein said image adjusting unit selects between execution and non-execution of a function in accordance with date and time monitored by said clock unit.

12. The multi-display apparatus according to claim 3, further comprising a clock unit, wherein said image adjusting unit selects between execution and non-execution of a function in accordance with date and time monitored by said clock unit.

13. The multi-display apparatus according to claim 1, wherein said viewer detecting unit includes:
a capture unit;
a face detecting unit that detects a human face facing a display surface of said display unit from an image captured by the capture unit; and
a viewer presence determining unit that determines whether or not a viewer is present in said near region based on a size and/or a position of the face in said image, when the face detecting unit detects the face.
